(19) United States
(12) Patent Application Publication
(10) Pub. No.: US 2004/0028242 A1
(43) Pub. Date: Feb. 12, 2004

(54) Audio reproducing apparatus and method

(75) Inventor: Mamoru Kitamura, Tokyo (JP)

Correspondence Address: CONNOLLY BOVE LODGE & HUTZ LLP, SUITE 800, 1990 M STREET NW, WASHINGTON, DC, 20036-3425, US

(73) Assignee: Niigata Seimitsu Co., Ltd., Niigata (JP)

(21) Appl. No.: 10/628,235

(22) Filed: Jul. 29, 2003

Related U.S. Application Data
(63) Continuation of application No. PCT/JP02/00581, filed on Jan. 28, 2002.

(30) Foreign Application Priority Data
Jan. 29, 2001 (JP) 2001-20047

(51) Int. Cl. H04R 3/00

(52) U.S. Cl. 381/96; 381/111

(57) ABSTRACT

A control loop for sensing the fluctuation of the source voltage (V₀) of a power amplifier (3) to feed it back to a switching regulator (5) is provided as well as a control loop to feed it forward to the switching regulator (5) by using PWM signal serving as the source for drive control of the power amplifier (3). The combination of feedback control and feedforward control more improves the precision of control than by just feedback control and results in an effective suppression of the fluctuation of the source voltage. The control can be carried out more simply than by the correction of the fluctuation of the source voltage through digital operation.

### BACKGROUND OF THE INVENTION

1. Field of the Invention

The present invention relates to an audio reproducing apparatus and a method thereof which are in particular suitable to be used for a digital power amplifier for reproducing and analog-outputting digital audio data recorded on a digital signal record medium such as a CD (Compact Disk).

2. Description of the Related Art

In the past, a PCM multi-bit method (hereafter, abbreviated as a PCM method) was adopted as means for representing audio information which is originally an analog signal as a digital signal. The PCM method is also adopted for a CD widely used today. In the case of the PCM method, an operation is performed according to quantization characteristics each time in timing of a sampling frequency (44.1 kHz) to replace the analog signal with the digital signal so as to record an absolute amount of data as to all sample points on the CD.

As opposed to this, attention is recently focused on a 1-bit method whereby distribution of quantization noise is controlled by using ΔΣ modulation and restorability from the digital signal to the original analog signal is thereby improved compared to the PCM method. In the case of the 1-bit method, only a variation against immediately preceding data is recorded as a binary signal without thinning out and interpolating an information amount as with the PCM method, and so a 1-bit signal obtained by quantization shows characteristics very close to those of the analog signal.

Therefore, an audio reproducing apparatus (digital power amplifier) based on the 1-bit method, that is, a so-called 1-bit amplifier has a merit that, unlike the PCM method, it does not require a D/A converter and is able to reproduce the original analog signal by a simple process of just eliminating the digital signal of a high-frequency component with a low-pass filter provided in a final stage.

FIG. 1 is a block diagram schematically showing a configuration of a 1-bit amplifier in the past. In FIG. 1, a ⊖Σ modulation portion 52 converts a digital audio 1-bit signal reproduced from a CD 51 based on the ΔΣ modulation so as to obtain a PWM (Pulse Width Modulation) signal. And it supplies the obtained PWM signal to a driver circuit 53. The driver circuit 53 generates a control signal for driving a power amplifier 54 by using the PWM signal supplied from the ΔΣ modulation portion 52.

The power amplifier 54 is comprised of a full-bridge switching circuit, and controls ON-state time of switching elements so as to amplify an audio signal based on a supplied source voltage and output it. The PWM signal having an analog-like width on a time base is used as the signal for controlling the switching. The audio signal amplified by the power amplifier 54 turns to an analog audio signal through a low-pass filter (LPF) 55 so as to be outputted from a speaker 56.

As described above, it is possible, by using the 1-bit amplifier of such a configuration, to reproduce the original analog signal in a simple process of just eliminating a high-frequency signal with the low-pass filter 55 without performing D/A conversion on reproduction. In the case of such a configuration, however, an error or a distortion occurs to the audio signal to be amplified due to fluctuation of the source voltage of the power amplifier 54 and so on, causing an adverse effect on reproduced sound quality.

To be more specific, when outputting a loud sound for instance, a very large amount of currents run in an output impedance of a power source so that the source voltage drops. If the source voltage drops, an output level of the audio signal hits the peak and becomes clipped to distort a waveform. Even in the case of outputting a comparatively soft sound, if a rising edge and a trailing edge of the signal to be outputted are precipitous, the source voltage drops or rises to cause a distortion of an output waveform.

To solve such problems, a proposal is made as to the 1-bit amplifier which feeds back an output signal of the power amplifier 54 having a fluctuant source voltage to the ΔΣ modulation portion 52 and corrects the fluctuation of the source voltage by using the feedback signal and then generates the PWM signal so as to adjust a pulse width of the PWM signal in real time.

However, there is a problem that the fluctuation of the source voltage cannot be completely eliminated even by the above-mentioned 1-bit amplifier equipped with a feedback loop and there are the cases where the waveform of the audio signal to be amplified is still distorted.

There is also a thinkable method of converting the audio signal including the fluctuation of the source voltage into a digital signal with an AD converter and performing a digital operation to correct the distortion. However, the operation in that case becomes very complicated, and so it is difficult to simply realize high performance.

The present invention was implemented in order to solve such problems, and its object is to allow the fluctuation of the source voltage used for the power amplifier to be more simply and securely suppressed so as to reduce degradation of the reproduced sound quality associated with the fluctuation of the source voltage.

### SUMMARY OF THE INVENTION

An audio reproducing apparatus according to the present invention is the one for amplifying an audio signal according to a pulse width modulation signal generated based on a digital audio signal and further filtering it so as to output an analog audio signal, the apparatus comprising: a first control loop for feeding back a source voltage supplied to amplification means for amplifying the audio signal and compensating a first signal used in a process of generating the pulse width modulation signal and amplifying the audio signal; and a second control loop for feeding forward a third signal generated from the pulse width modulation signal to a supply control portion of a power source for amplification to compensate a second signal for controlling supply of the power source for amplification.

Another aspect of the present invention is characterized in that the first and second signals are the same.

A further aspect of the present invention is the audio reproducing apparatus for amplifying the audio signal according to the pulse width modulation signal generated based on the digital audio signal and further filtering it so as to output the analog audio signal, the apparatus comprising: the first control loop for feeding back the source voltage supplied to the amplification means for amplifying the audio signal to the supply control portion of the power source for amplification; and a second control loop for generating a signal of approximately the same amplitude as the source voltage supplied to the amplification means and of an opposite phase based on the pulse width modulation signal and feeding it forward to the supply control portion of the power source for amplification, and controlling the supply of the power source for amplification by using the first and second control loops.

A still further aspect of the present invention is comprising: modulation means performing a convert process based on modulation to an inputted digital audio signal and generating the pulse width modulation signal; the amplification means for amplifying the audio signal based on the pulse width modulation signal generated by the modulation means; filter means for filtering the signal outputted from the amplification means and thereby generating the analog audio signal; power source supply control means for controlling the supply of the power source for amplification to the amplification means according to a predetermined control signal; and compensation means for feedback-inputting the signal of the amplitude according to the source voltage supplied to the amplification means and generating and feedforward-inputting the signal of approximately the same amplitude as the source voltage supplied to the amplification means and of the opposite phase based on the pulse width modulation signal generated by the modulation means so as to compensate the predetermined control signal.

A still further aspect of the present invention is characterized in that the power source supply control means is a switching regulator for exerting control to intermittently supply power from the power source for amplification to the amplification means according to the predetermined control signal; and the compensation means compensates the pulse width of the predetermined control signal based on the feedback-inputted and feedforward-inputted signals.

A still further aspect of the present invention is comprising: ΔΣ modulation means for performing a convert process based on ΔΣ modulation to an inputted digital audio signal and generating the pulse width modulation signal; the amplification means for amplifying the audio signal based on the pulse width modulation signal generated by the ΔΣ modulation means; the filter means for filtering the signal outputted from the amplification means and thereby generating the analog audio signal; the power source supply control means for controlling the supply of the power source for amplification to the amplification means according to the predetermined control signal; triangular wave generation means for generating a triangular wave signal based on a predetermined clock signal; signal generation means for generating the signal of approximately the same amplitude as the source voltage supplied to the amplification means and of the opposite phase based on the pulse width modulation signal generated by the ΔΣ modulation means; first comparison means for inputting to one input terminal the signal of the amplitude according to the source voltage supplied to the amplification means and inputting to the other input terminal the signal from the power source for amplification and the signal generated by the signal generation means so as to compare the two input signals and generate a difference signal; and second comparison means for inputting to one input terminal the triangular wave signal generated by the triangular wave generation means and inputting to the other input terminal the difference signal outputted from the first comparison means so as to compare the two input signals, generate the predetermined control signal and supply it to the power source supply control means.

A still further aspect of the present invention is comprising: the ΔΣ modulation means for performing a convert process based on ΔΣ modulation to an inputted digital audio signal and generating the pulse width modulation signal; the amplification means for amplifying the audio signal based on the pulse width modulation signal generated by the ΔΣ modulation means; the filter means for filtering the signal outputted from the amplification means and thereby generating the analog audio signal; the power source supply control means for controlling the supply of the power source for amplification to the amplification means according to the predetermined control signal; the triangular wave generation means for generating a triangular wave signal based on the predetermined clock signal; the signal generation means for generating the signal of approximately the same amplitude as the source voltage supplied to the amplification means and of the opposite phase based on the pulse width modulation signal generated by the ΔΣ modulation means; the first comparison means for inputting to one input terminal the signal of the amplitude according to the source voltage supplied to the amplification means and the signal generated by the signal generation means and inputting to the other input terminal the signal from the power source for amplification so as to compare the two input signals and generate the difference signal; and the second comparison means for inputting to one input terminal the triangular wave signal generated by the triangular wave generation means and inputting to the other input terminal the difference signal outputted from the first comparison means so as to compare the two input signals, generate the predetermined control signal and supply it to the power source supply control means.

A still further aspect of the present invention is the audio reproducing apparatus for amplifying the audio signal according to the pulse width modulation signal generated based on the digital audio signal and further filtering it so as to output the analog audio signal, the apparatus characterized by detecting the source voltage supplied to the amplification means for amplifying the audio signal and feeding it back to the supply control portion of the power source for amplification so as to compensate the pulse width of the control signal for controlling the supply of the power source for amplification based on the source voltage fed back.

A still further aspect of the present invention is the audio reproducing apparatus for amplifying the audio signal according to the pulse width modulation signal generated based on the digital audio signal and further filtering it so as to output the analog audio signal, the apparatus characterized by generating the signal of approximately the same amplitude as the source voltage supplied to the amplification means and of the opposite phase based on the pulse width modulation signal and feeding it forward to the supply control portion of the power source for amplification so as to compensate the pulse width of the control signal for controlling the supply of the power source for amplification based on the signal fed forward.

An audio reproducing method according to the present invention is the one for amplifying the audio signal according to the pulse width modulation signal generated based on the digital audio signal and further filtering it so as to output the analog audio signal, the method characterized by feedback-inputting the signal of the amplitude according to the source voltage supplied to the amplification means for amplifying the audio signal and generating and feedforward-inputting the signal of approximately the same amplitude as the source voltage supplied to the amplification means and of the opposite phase based on the pulse width modulation signal so as to compensate the predetermined control signal used in the process of generating the pulse width modulation signal and amplifying the audio signal.

Another aspect of the present invention is the audio reproducing method for amplifying the audio signal according to the pulse width modulation signal generated based on the digital audio signal and further filtering it so as to output the analog audio signal, the method characterized by feeding back the signal of the amplitude according to the source voltage supplied to the amplification means for amplifying the audio signal to the supply control portion of the power source for amplification and generating the signal of approximately the same amplitude as the source voltage supplied to the amplification means and of the opposite phase based on the pulse width modulation signal and feeding it forward to the supply control portion of the power source for amplification so as to compensate the predetermined control signal used for controlling the supply of the power source for amplification to the amplification means.

According to the present invention constituted as above, the source voltage supplied to the amplification means is detected and feedback-controlled so that the fluctuation of the source voltage is compensated by using a feedback signal. In addition, the signal of approximately the same amplitude as the source voltage supplied to the amplification means and of the opposite phase is generated from the pulse width modulation signal to be a source for controlling a drive of the amplification means and is feedforward-controlled so that compensation is made to offset the fluctuation of the source voltage in advance by using a feedforward signal.

### BRIEF DESCRIPTION OF THE DRAWINGS

FIG. 1 is a diagram showing a configuration of a 1-bit amplifier of the prier art;

FIG. 2 is a diagram showing a configuration example of the 1-bit amplifier according to this embodiment implementing an audio reproducing apparatus according to the present invention;

FIG. 3 is a waveform chart for explaining operation of first and second comparators and a triangular wave generation portion;

FIG. 4 is a diagram for explaining a principle of operation of feedforward control according to this embodiment; and

FIG. 5 is a diagram showing another configuration example of the 1-bit amplifier according to this embodiment.

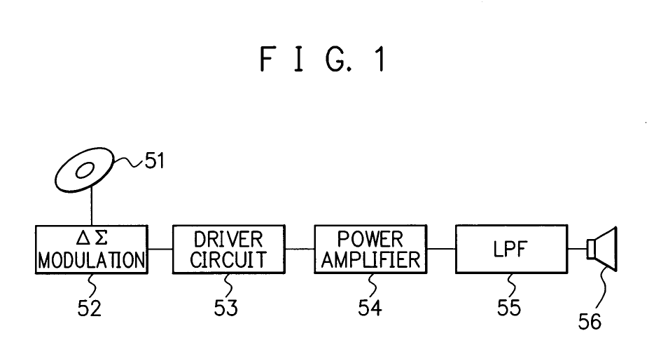

### DETAILED DESCRIPTION OF THE EMBODIMENTS

Hereafter, an embodiment of the present invention will be described based on the drawings.

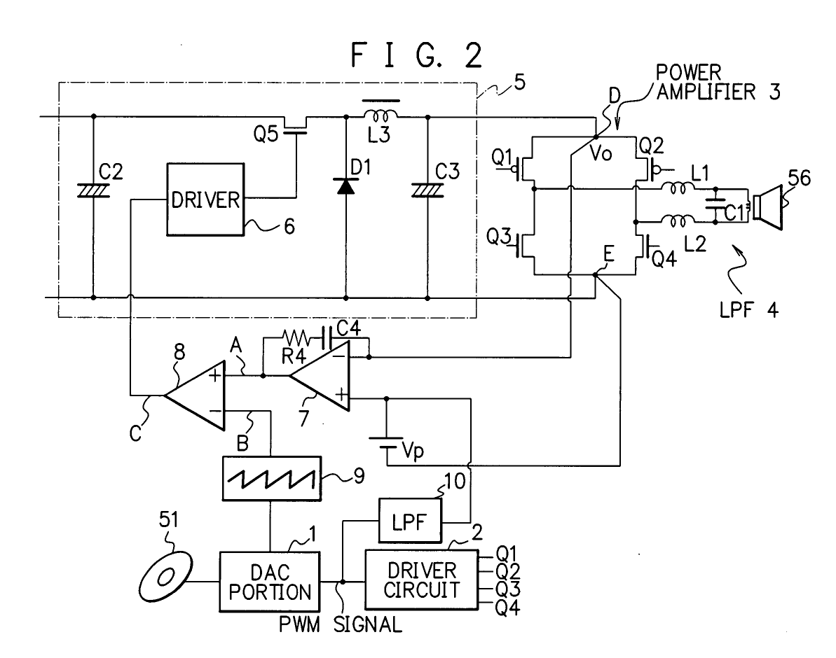

FIG. 6 is a diagram showing a configuration example of a 1-bit amplifier according to this embodiment implementing an audio reproducing apparatus according to the present invention. As shown in FIG. 2, the 1-bit amplifier according to this embodiment has a DAC portion 1, a driver circuit 2, a power amplifier 3 and an LPF 4, where the driver circuit 2 controls amplification time of the power amplifier 3 based on a PWM signal generated in the DAC portion 1 from a digital audio signal reproduced from a CD 51 and passes an obtained amplification signal through the LPF4 so as to obtain an analog audio signal.

The DAC portion 1 converts a digital audio 1-bit signal reproduced from the CD 51 based on the ΔΣ modulation so as to obtain the PWM signal. The DAC portion 1 has a ΔΣ modulation process portion for generating the PWM signal by converting a digital 1-bit signal reproduced from a CD 51 based on the ΔΣ modulation, a timing controller for controlling operation timing thereof based on a clock signal sent out from a crystal oscillator and so on.

The driver circuit 2 generates a drive control signal of the power amplifier 3 by using the PWM signal supplied from the DAC portion 1. And it controls time for keeping switching elements (pMOS transistors Q1, Q2 and nMOS transistors Q3, Q4) constituting the power amplifier 3 with a full bridge in an ON state to drive it. Thus, the power amplifier 3 amplifies and outputs the audio signal based on a source voltage supplied from a power source Vp for a controlled driving time.

The audio signal amplified by the power amplifier 3 turns to the analog audio signal through the LPF4 comprised of coils L1, L2 and a capacitor C1 so as to be outputted from a speaker 56.

The power source Vp for supplying the source voltage to the power amplifier 3 has a switching regulator 5 provided thereon. The switching regulator 5 has an nMOS transistor Q5 which is a switching element, a driver 6 for driving the nMOS transistor Q5, a coil L3 connected between the nMOS transistor Q5 and power amplifier 3, and capacitors C2, C3 and a diode D1 mutually connected in parallel between signal lines of the nMOS transistor Q5 and coil L3 and a ground.

The switching regulator 5 controls power from the power source Vp with the nMOS transistor Q5 to intermittently supply it to the power amplifier 3, and changes a time ratio of ON versus OFF in an interruption period or a period so as to provide predetermined load power to the power amplifier 3. In this case, a control signal for controlling ON and OFF of the nMOS transistor Q5 is generated based on a signal and so on including a fluctuation of a source voltage V₀ fed back from the power amplifier 3.

To be more specific, in order to detect the fluctuation of a source voltage V₀ supplied to the power amplifier 3, a node D on a power source side of the power amplifier 3 is connected to an input terminal on a negative side of a first comparator 7, and a node E on a ground side of the power amplifier 3 is connected to the input terminal on a positive side of the first comparator 7 via the power source Vp. Thus, the source voltage V₀ of the power amplifier 3 is supplied to the input terminal on the negative side of the first comparator 7, and a positive voltage of the power source Vp is supplied to the input terminal on the positive side.

The first comparator 7 compares the signal supplied from the power source Vp to the signal of an amplitude according to the source voltage V₀ supplied from the power amplifier 3, and generates a difference signal thereof to output it to the input terminal on the positive side of a second comparator 8. In this case, a resistance R4 and a capacitor C4 filter an obtained difference signal to smooth it. A triangular wave signal generated by a triangular wave generation portion 9 is inputted to the negative side of the second comparator 8.

The second comparator 8 compares the difference signal outputted from the first comparator 7 to the triangular wave signal generated by the triangular wave generation portion 9 so as to generate a pulse signal for controlling driving of the nMOS transistor Q5 in the switching regulator 5. The pulse signal thus generated is supplied to the driver 6 in the switching regulator 5, and the ON and OFF of the nMOS transistor Q5 is thereby controlled.

The triangular wave generation portion 9 repeats an operation of, as to each pulse of a clock signal outputted from an unshown timing controller in the DAC portion 1 (same as the a clock signal supplied to the ΔΣ modulation process portion), integrating and resetting the signal by an equivalent of the time of that pulse width so as to generate the triangular wave signal. It is possible to prevent unnecessary interference due to use of a plurality of clocks by using as an original signal for generating the triangular wave signal the same clock signal as the clock signal for controlling the ΔΣ modulation process portion and so on in the DAC portion 1.

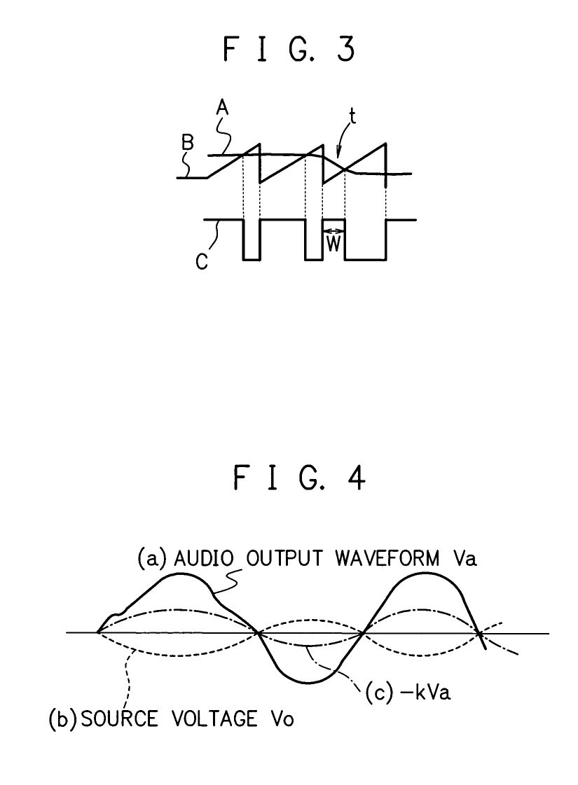

FIG. 3 is a waveform chart showing a state of generating the pulse signal for determining drive timing of the nMOS transistor Q5 from the difference signal outputted from the first comparator 7 and the triangular wave signal generated by the triangular wave generation portion 9.

In FIG. 3, the triangular wave signal of a node B to be inputted to the terminal on the negative side of the second comparator 8 is a threshold for determining either “H” or “L” as to the pulse signal of an output node C of the second comparator 8. To be more specific, the pulse signal of the output node C of the second comparator 8 becomes “H” where the level of the difference signal of a node A inputted to the terminal on the positive side of the second comparator 8 is higher than that of the triangular wave signal of the node B inputted to the terminal on the negative side, and becomes “L” where the level of the difference signal is lower than that of the triangular wave signal.

In such an operating state, if the fluctuation occurs to the source voltage V₀ in certain timing t, the difference signal of the node A outputted from the first comparator 7 changes as in FIG. 3 for instance. The threshold of the second comparator 8 thereby fluctuates, and so the pulse width of the pulse signal of the node C also changes as in FIG. 3. Thus, it becomes possible to render the drive timing of the nMOS transistor Q5 in the switching regulator 5 variable according to the fluctuation of the source voltage V₀ so as to control the supply of the source voltage from the power source Vp to the power amplifier 3.

For instance, if the source voltage V₀ rises in certain timing t, the difference signal of the node A outputted from the first comparator 7 changes in a direction to become smaller as in FIG. 3. Thus, a pulse width W of the pulse signal of the node C outputted from the second comparator 8 becomes narrower than before then. Thus, the time during which the nMOS transistor Q5 in the switching regulator 5 is ON becomes shorter so that the source voltage V₀ supplied to the power amplifier 3 becomes lower so as to suppress the fluctuation of a source voltage V₀.

According to this embodiment, the pulse width of the PWM signal is not compensated by feeding back an output signal of the power amplifier 3 to the ΔΣ modulation process portion in the DAC portion 1, but the source voltage itself is fed back to the switching regulator 5 for controlling the supply of the source voltage from the power source Vp so as to directly control the supply of the source voltage according to the fluctuation of the source voltage. Therefore, it is possible to exert feedback control with better accuracy compared to the past.

According to this embodiment, a feedforward control loop described below is constituted in addition to the feedback control loop for the power source Vp as described above. To be more specific, an LPF 10 is provided to perform a low-pass filter process to a digital PWM signal generated by the DAC portion 1, and an analog PWM signal is generated by the LPF 10. And the analog PWM signal is supplied to the input terminal on the positive side of the first comparator 7. Compensation means of the present invention is comprised of the first and second comparators 7 and 8 triangular wave generation portion 9 and the LPF 10 described above.

The PWM signal is the signal as a source for controlling the time for amplifying the audio signal, and so it is possible, according to the pulse width of the PWM signal, to predict the amplification time of the audio signal, that is, the amplitude of the audio signal in advance. For instance, it is possible, when the pulse width of the PWM signal is large, to predict that the audio signal of a large amplitude is outputted as a reproduced sound. The source voltage V₀ generated in the power amplifier 3 fluctuates according to the amplitude of the reproduced audio signal.

Therefore, it can be said that the PWM signal and the fluctuation of the source voltage V₀ are correlated to a certain extent. Thus, according to this embodiment, the PWM signal is fed forward to the switching regulator 5 to control the supply of the power from the power source Vp so as to suppress the fluctuation of the source voltage V₀ generated in the power amplifier 3.

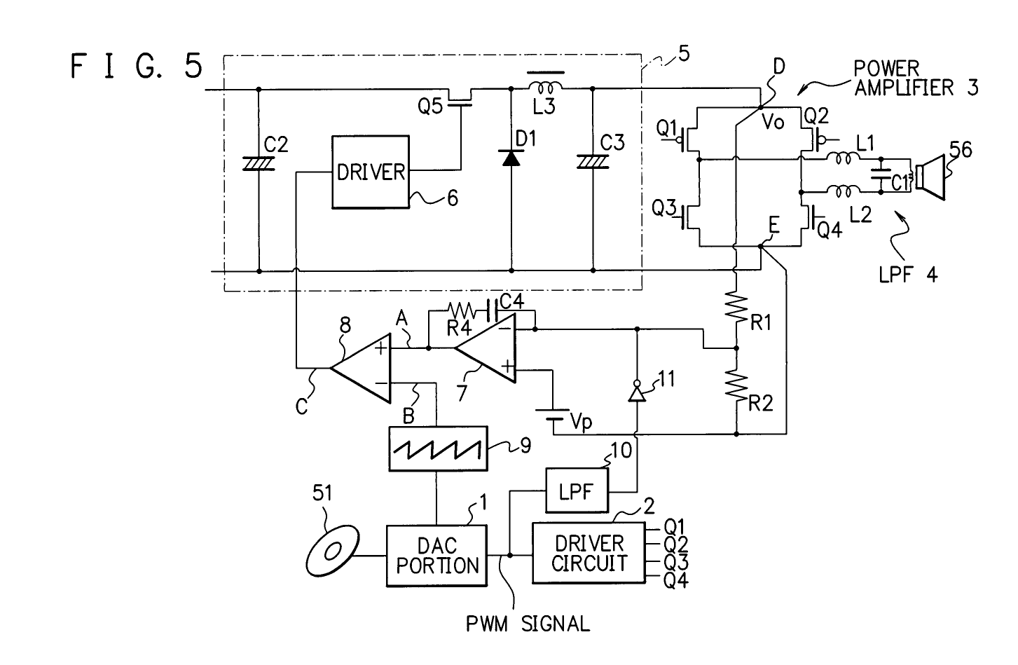

FIG. 4 is a diagram for explaining a principle of operation of feedforward control according to this embodiment. Here, a waveform Va of the audio signal amplified by the power amplifier 3 and outputted from the speaker 56 is like FIG. 4(a). In this case, the source voltage V₀ supplied to the power amplifier 3 fluctuates like FIG. 4(b) according to the amplitude of the audio output waveform Va.

According to this embodiment, a low-pass filtering is performed to the PWM signal outputted from the DAC portion 1 at the LPF 10 as shown in FIG. 2, and the output signal thereof is fed forward to the switching regulator 5 via the first and second comparators 7 and 8 so as to exert control to only compensate the voltage by an equivalent of the waveform shown in FIG. 4(c). The waveform shown in FIG. 4(c) is the one of an opposite phase to the fluctuation of the source voltage V₀ shown in FIG. 4(b) and having almost equal amplitude. Feedforward control of the waveform like FIG. 4(c) is exerted so as to cancel the fluctuation of the source voltage V₀ by offsetting it in advance.

To be more precise, when generating the analog PWM signal at the LPF 10, the amplitude of the analog PWM signal is controlled so that the waveform in FIG. 4(c) becomes—kVa (k is a coefficient). An output impedance of the power source Vp which is a factor of the fluctuation of the source voltage V₀ is almost determined by characteristics of the capacitors C2 and C3 of the switching regulator 5, and so the value of a coefficient k necessary to suppress the fluctuation of the source voltage V₀ is almost uniquely determined by the characteristics of the capacitors C2, C3 and so on. Therefore, it is possible to design the LPF 10 in advance so that the feedforward control like FIG. 4(c) can be exerted.

As described in detail above, in addition to a first control loop for detecting the fluctuation of the source voltage V₀ occurring to the power amplifier 3 and feeding it back to the switching regulator 5 of the power source Vp, this embodiment provides a second control loop for feeding it forward to the switching regulator 5 by using the PWM signal generated by the DAC portion 1.

Thus, it is possible, compared to the cases of simply exerting feedback control, to improve the accuracy of the control and effectively suppress the fluctuation of the source voltage which cannot be eliminated just by the feedback control. In addition, it is possible to exert control more simply compared to a compensation method of digitalizing the audio signal and performing digital operation. Therefore, it is feasible, according to this embodiment, to simply and more securely suppress degradation of reproduced sound quality associated with the fluctuation of the source voltage and so on.

FIG. 5 is a diagram showing another configuration example of the 1-bit amplifier according to this embodiment, and components having the same functions as those shown in FIG. 2 are given the same symbols. As for the 1-bit amplifier shown in FIG. 5, a phase is inverted by passing the analog PWM signal outputted from the LPF 10 through an inverter 11, and the phase-inverted signal is supplied to the input terminal on the negative side of the first comparator 7.

To be more specific, as for the example in FIG. 5, the PWM signal controls the source voltage V₀ itself to be fed back from the power amplifier 3 to the switching regulator 5. In this case, the source voltage V₀ to be fed back from the power amplifier 3 is divided into partial pressures of adequate values by two resistances R1 and R2 so as to be supplied to the input terminal on the negative side of the first comparator 7.

In the case where it is thus constituted, it is also possible, compared to the cases of simply exerting feedback control, to improve the accuracy of the control and effectively suppress the fluctuation of the source voltage which cannot be eliminated just by the feedback control. In addition, it is possible to exert control more simply compared to a compensation method by the digital operation. Therefore, it is feasible to simply and more securely suppress the degradation of reproduced sound quality associated with the fluctuation of the source voltage and so on.

The embodiment described above shows just one example of concretization in implementing the present invention, and a technical scope of the present invention should not thereby be interpreted in a limited way. To be more specific, the present invention can be implemented in various forms without deviating from its spirit or its major characteristics.

For instance, according to the above embodiment, the LPF 10 itself is designed so that, when feeding forward the analog PWM signal, the control is exerted by the waveform of—kVa shown in FIG. 4(c). As opposed to this, it is also possible to have the LPF 10 normally perform the low-pass filtering and invert the phase to its output signal so as to separately provide a circuit to be multiplied by the coefficient k.

Although both the feedback control loop and feedforward control loop constitute the control loops for the power source Vp according to the above embodiment, it is not necessarily limited to this example. For instance, the feedback control loop may also be the control loop for compensating the pulse width of the PWM signal by feeding it back to the DAC portion 1, the control loop for compensating the pulse width of the drive control signal of the power amplifier 3 by feeding it back to the driver circuit 2 or any other control loop.

As described above, according to the present invention, it is possible, in addition to detecting and feedback-controlling the source voltage of the amplification means, to feedforward-control it by using a pulse width modulation signal to be a source for controlling a drive of the amplification means so as to improve the accuracy of the control and effectively suppress the fluctuation of the source voltage compared to the cases of simply exerting the feedback control. In addition, it is possible to exert control more simply compared to the method of compensating the fluctuation of the source voltage by the digital operation. Therefore, it is feasible to simply and more securely suppress the degradation of reproduced sound quality associated with the fluctuation of the source voltage and so on.

In addition, it is possible, by constituting as the feedback control loop the control loop for detecting the source voltage of the amplification means and feeding it back to a supply control portion of the power source, to directly control the fluctuation of the source voltage by controlling the supply of the power so as to improve the accuracy of the control. Likewise, it is also possible, as to the feedforward control loop, to perform feedforward to the supply control portion of the power source by using the PWM signal and thereby directly suppress the fluctuation of the source voltage so as to improve the accuracy of the control.

### INDUSTRIAL APPLICABILITY

The present invention is instrumental in more simply and securely suppressing the fluctuation of the source voltage used for the power amplifier so as to reduce the degradation of reproduced sound quality associated with the fluctuation of the source voltage.

What is claimed is:

1. An audio reproducing apparatus for amplifying an audio signal according to a pulse width modulation signal generated based on a digital audio signal and further filtering it so as to output an analog audio signal, the apparatus comprising:
a first control loop for feeding back a source voltage supplied to amplification means for amplifying the audio signal to a supply control portion of a power source for amplification and compensating a pulse width of a control signal for controlling supply of the power source for amplification; and
a second control loop for feeding forward the pulse width modulation signal to the supply control portion of the power source for amplification to compensate the pulse width of the control signal.

2. An audio reproducing apparatus for amplifying an audio signal according to a pulse width modulation signal generated based on a digital audio signal and further filtering it so as to output an analog audio signal, the apparatus comprising:
a first control loop for feeding back a source voltage supplied to amplification means for amplifying the audio signal to a supply control portion of a power source for amplification; and
a second control loop for generating a signal of approximately the same amplitude as the variation of the source voltage supplied to the amplification means and of an opposite phase based on the pulse width modulation signal and feeding it forward to the supply control portion of the power source for amplification, and
controlling the supply of the power source for amplification by using the first and second control loops.

3. An audio reproducing apparatus comprising:
modulation means for performing a convert process based on modulation to an inputted digital audio signal and generating a pulse width modulation signal;
amplification means for amplifying an audio signal based on the pulse width modulation signal generated by the modulation means;
filter means for filtering a signal outputted from the amplification means and thereby generating an analog audio signal;
power source supply control means for controlling supply of a power source for amplification to the amplification means according to a predetermined control signal; and
compensation means for feedback-inputting the signal of the amplitude according to a source voltage supplied to the amplification means and generating and feedforward-inputting the signal of approximately the same amplitude as the variation of the source voltage supplied to the amplification means and of the opposite phase based on the pulse width modulation signal generated by the modulation means so as to compensate the predetermined control signal.

4. The audio reproducing apparatus according to claim 3,
the power source supply control means is a switching regulator for exerting control to intermittently supply power from the power source for amplification to the amplification means according to the predetermined control signal; and
the compensation means compensates the pulse width of the predetermined control signal based on the feedback-inputted and feedforward-inputted signals.

5. An audio reproducing apparatus comprising:
ΔΣ modulation means for performing a convert process based on ΔΣ modulation to an inputted digital audio signal and generating a pulse width modulation signal;
amplification means for amplifying the audio signal based on the pulse width modulation signal generated by the ΔΣ modulation means;
filter means for filtering a signal outputted from the amplification means and thereby generating an analog audio signal;
power source supply control means for controlling supply of a power source for amplification to the amplification means according to a predetermined control signal;
triangular wave generation means for generating a triangular wave signal based on a predetermined clock signal;
signal generation means for generating a signal of approximately the same amplitude as the variation of a source voltage supplied to the amplification means and of the opposite phase based on the pulse width modulation signal generated by the ΔΣ modulation means;
first comparison means for inputting to one input terminal the signal of the amplitude according to the source voltage supplied to the amplification means and inputting to the other input terminal the signal from the power source for amplification and the signal generated by the signal generation means so as to compare the two input signals and generate a difference signal; and
second comparison means for inputting to one input terminal the triangular wave signal generated by the triangular wave generation means and inputting to the other input terminal the difference signal outputted from the first comparison means so as to compare the two input signals, generate the predetermined control signal and supply it to the power source supply control means.

6. An audio reproducing apparatus comprising:
ΔΣ modulation means for performing a convert process based on ΔΣ modulation to an inputted digital audio signal and generating a pulse width modulation signal;
amplification means for amplifying the audio signal based on the pulse width modulation signal generated by the ΔΣ modulation means;
filter means for filtering a signal outputted from the amplification means and thereby generating an analog audio signal;
power source supply control means for controlling supply of a power source for amplification to the amplification means according to a predetermined control signal;
triangular wave generation means for generating a triangular wave signal based on a predetermined clock signal;
signal generation means for generating the signal of approximately the same amplitude as the variation of a source voltage supplied to the amplification means and of the opposite phase based on the pulse width modulation signal generated by the ΔΣ modulation means;
first comparison means for inputting to one input terminal the signal of the amplitude according to the source voltage supplied to the amplification means and the signal generated by the signal generation means and inputting to the other input terminal the signal from the power source for amplification so as to compare the two input signals and generate a difference signal; and
second comparison means for inputting to one input terminal the triangular wave signal generated by the triangular wave generation means and inputting to the other input terminal the difference signal outputted from the first comparison means so as to compare the two input signals, generate the predetermined control signal and supply it to the power source supply control means.

7. An audio reproducing apparatus for amplifying an audio signal according to a pulse width modulation signal generated based on a digital audio signal and further filtering it so as to output an analog audio signal, the apparatus characterized by detecting a source voltage supplied to amplification means for amplifying the audio signal and feeding it back to a supply control portion of a power source for amplification so as to compensate a pulse width of a control signal for controlling supply of the power source for amplification based on the source voltage fed back.

8. An audio reproducing apparatus for amplifying an audio signal according to a pulse width modulation signal generated based on a digital audio signal and further filtering it so as to output an analog audio signal, the apparatus characterized by generating a signal of approximately the same amplitude as the variation of a source voltage supplied to amplification means and of the opposite phase based on the pulse width modulation signal and feeding it forward to a supply control portion of the power source for amplification so as to compensate a pulse width of a control signal for controlling supply of the power source for amplification based on the signal fed forward.

9. An audio reproducing method for amplifying an audio signal according to a pulse width modulation signal generated based on a digital audio signal and further filtering it so as to output an analog audio signal, the method characterized by feeding back a signal of an amplitude according to a source voltage supplied to amplification means for amplifying the audio signal to a supply control portion of a power source for amplification and generating the signal of approximately the same amplitude as the variation of the source voltage supplied to the amplification means and of the opposite phase based on the pulse width modulation signal and feeding it forward to the supply control portion of the power source for amplification so as to compensate the pulse width of a predetermined control signal used for controlling supply of the power source for amplification to the amplification means.
